(19) United States
(12) Patent Application Publication
(10) Pub. No.: US 2021/0114302 A1
(43) Pub. Date: Apr. 22, 2021

(54) SHAPING APPARATUS AND METHOD FOR MANUFACTURING SHAPED MATERIAL

(71) Applicant: CANON KABUSHIKI KAISHA, Tokyo (JP)

(72) Inventors: Kanta Nakagawa, Kanagawa (JP); Takuya Shimizu, Kanagawa (JP)

(21) Appl. No.: 17/067,395

(22) Filed: Oct. 9, 2020

(30) Foreign Application Priority Data
Oct. 16, 2019 (JP) 2019-189802

(51) Int. Cl. B29C 64/321; B29C 64/135; B29C 64/20; B33Y 10/00; B33Y 30/00

(52) U.S. Cl. CPC B29C 64/321; B29C 64/135; B33Y 30/00; B33Y 10/00; B29C 64/20

(57) ABSTRACT

A container configured to store a material, a curing-light-irradiating unit configured to cure the material, a work table on which the resulting cured material is placed, a material feed portion configured to discharge the material onto the work table, and a feed tube configured to transport the material from the container to the material feed portion are included, wherein the material feed portion has an agitator configured to agitate the material transported from the container.

### BACKGROUND

### Field of the Disclosure

The present disclosure relates to a shaping apparatus and a method for manufacturing a shaped material, in which a resin material is selectively irradiated with curing light configured to cure the resin material so as to form cured layers and a three-dimensional object is produced by successively stacking the resulting cured layers.

### Description of the Related Art

A shaping method using a material in which inorganic fillers such as silica are mixed is a known method for producing a shaped material having excellent strength.

The shaped material produced by using a filler-containing material has improved bending strength or tensile strength compared with a shaped material produced by using a filler-free material, but there is a problem of variations in the mechanical characteristics tending to occur in accordance with changes in the filler content of each part or with the filler dispersion state in a single part.

Regarding a method for producing a shaped material in which variations do not readily occur in the mechanical characteristics by using a filler-containing material, a method in which a material agitated in a tank having an agitation mechanism is transported to a feed nozzle, a predetermined amount of the material is fed from the feed nozzle to a processing zone, and photo-curing is performed is known (refer to Japanese Patent Laid-Open No. 09-131800).

However, the method described in Japanese Patent Laid-Open No. 09-131800 has a problem of separation of filler due to precipitation occurring during material transportation from the container to the feed nozzle or in the feed nozzle.

### SUMMARY

The present disclosure provides a shaping apparatus and a method for manufacturing a shaped material, in which separation of filler due to precipitation is suppressed from occurring during shaping.

A shaping apparatus according to the present disclosure is configured to shape a shaped material by irradiating a material discharged from a material feed portion with light so as to cure the material, wherein the material feed portion has an agitator configured to agitate the material before discharge.

A method for manufacturing a shaped material according to the present disclosure includes repetition of the steps of discharging a material from a material feed portion, stopping discharge of the material from the material feed portion, and, in addition, forming a cured layer by irradiating the discharged material with curing light, wherein the material feed portion agitates the material stored in the material feed portion while discharge of the material is stopped.

Further features of the present disclosure will become apparent from the following description of exemplary embodiments with reference to the attached drawings.

### BRIEF DESCRIPTION OF THE DRAWINGS

FIG. 1 is a simplified sectional view of a shaping apparatus according to a first embodiment.

FIG. 2 is a simplified sectional view of a shaping apparatus according to a modified example of the first embodiment.

Each of FIGS. 3A and 3B is a simplified sectional view of a material feed portion.

FIG. 4 is a simplified sectional view of a shaping apparatus according to a second embodiment.

FIG. 5 is a simplified sectional view of a shaping apparatus according to a modified example of the second embodiment.

FIG. 6 is a schematic diagram illustrating a dumbbell type tensile test piece specified in accordance with JIS and produced in the example.

FIG. 7 is a block diagram illustrating a configuration example of the control system of a shaping apparatus according to the first embodiment.

FIG. 8 is a block diagram illustrating a configuration example of the control system of a shaping apparatus according to the second embodiment.

### DESCRIPTION OF THE EMBODIMENTS

The embodiments according to the present invention will be described below in detail.

In this regard, the configuration described below is just an exemplification, and, for example, details of the configuration may be appropriately modified by a person skilled in the art within the bounds of not departing from the gist of the present invention.

### First Embodiment

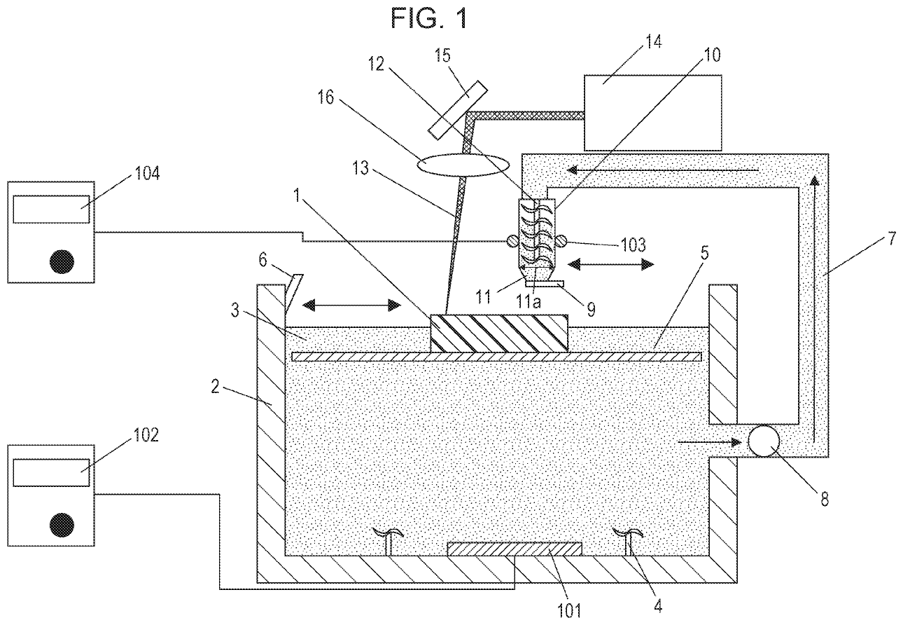

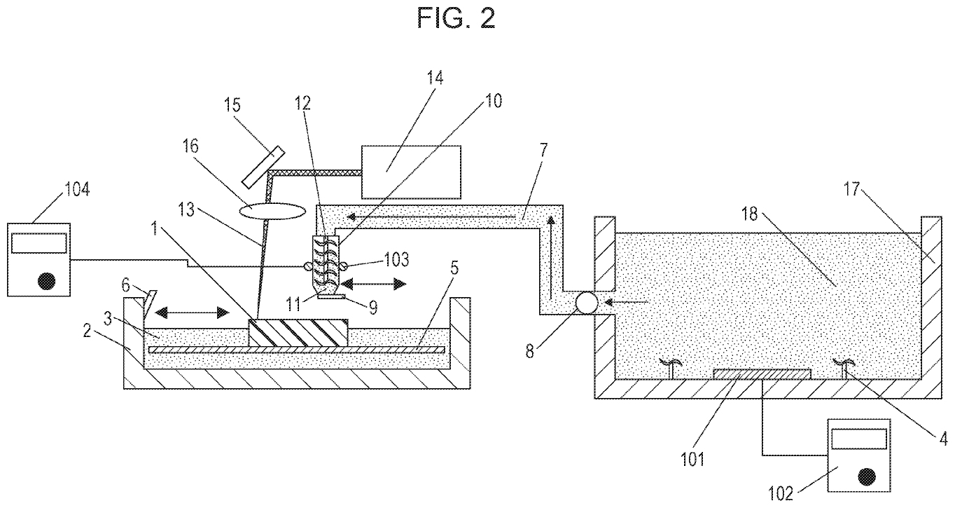

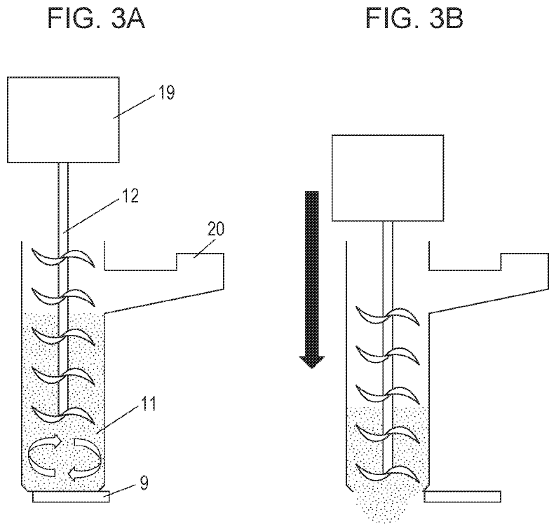

FIG. 1 is a simplified sectional view illustrating a first embodiment that is an example of a shaping apparatus according to the present invention. FIG. 2 is a simplified sectional view illustrating a modified example of the first embodiment. Regarding FIG. 2, the same components as those in FIG. 1 are indicated by the same references, and explanations thereof are omitted. In FIG. 1, reference 1 denotes a shaped material that is shaped by a shaping apparatus according to the present embodiment. Reference 2 denotes a container. A filler-containing material 3 in a molten (uncured) state is stored in the container 2.

The material 3 can be a material that is cured by light (material), and examples of radical-polymerization-based resin materials include acrylate-based materials. In particular, in this case, an oligomer used as the material for forming the material 3 may be selected from oligomers based on urethane acrylate, epoxy acrylate, polyester acrylate, acryl acrylate, and the like.

Regarding the filler, known materials such as inorganic particles and organic polymer particles may be used. In this regard, a powder-like filler or a fiber-like filler may be adopted. Specifically, glass powder, silica powder, alumina, alumina hydrate, magnesium oxide, magnesium hydroxide, barium sulfate, calcium sulfate, calcium carbonate, magnesium carbonate, and the like may be used. In addition, silicate minerals, diatomaceous earth, silica sand, silica rock powder, titanium oxide, aluminum powder, bronze powder, zinc powder, copper powder, lead powder, gold powder, silver powder, glass fiber, and the like may be used. Further, potassium titanate whiskers, carbon whiskers, sapphire whiskers, beryllia whiskers, boron carbide whiskers, silicon carbide whiskers, silicon nitride whiskers, and the like may be used. In the present specification, reinforcing particles that enhance the strength and the heat resistance of the shaped material after curing are referred to as filler.

Reference 13 denotes curing light configured to cure the material 3. In the present embodiment, an example in which irradiation is performed from above the container 2 is described. Reference 5 denotes a work table that functions as a base plate configured to support a cured material (shaped material 1) produced by curing the material 3 by using the curing light 13. The work table 5 is movable downward by a lift (not illustrated in the drawing) in accordance with solidification progress and shaping of the cured material.

Reference 10 denotes a material feed portion configured to feed the material 3 onto the work table 5 (also referred to as a material feed portion). Each of FIGS. 3A and 3B is an enlarged view of the material feed portion 10. In FIGS. 3A and 3B, reference 12 denotes an agitation mechanism having, for example, a screw mechanism, reference 19 denotes a driving motor, and reference 20 denotes a material introduction port. The filler-containing material 3 in a molten (uncured) state stored in the container 2 is suctioned by a pump 8 controlled by a container control portion 613 described later and is fed to and stored in the material feed portion 10 through a feed tube 7 and the material introduction port 20. The material feed portion 10 including the agitation mechanism 12 enables separation of filler due to precipitation to be suppressed from occurring during material feeding. In the present embodiment, although the example in which the material feed portion 10 includes a cooling mechanism 103 is described, the cooling mechanism is not limited to being included. Including the cooling mechanism 103 enables the viscosity to be adjusted by cooling the material in the material feed portion 10. Reference 104 denotes an apparatus configured to measure and display the temperature of the cooling mechanism 103. A viscosity measuring instrument (not illustrated in the drawing) configured to measure the viscosity of the material in the material feed portion 10 may be attached. Consequently, the material that consistently maintains an appropriate viscosity is fed onto the work table 5 or the cured material, and separation of filler due to precipitation is further suppressed from occurring after feeding until the cured layer is formed by light beam irradiation.

The container 2 may include a heater 101 and/or an agitation mechanism 4, but the heater 101 and/or the agitation mechanism 4 is not limited to being included. Reference 102 denotes an apparatus configured to measure and display the temperature of the heater 101. The heater 101 and/or the agitation mechanism 4 is controlled by the container control portion 613 described later. Control of the heater 101 and/or the agitation mechanism 4 by the container control portion 613 enables the material 3 to be stored in the container 2 while the filler is in a more uniformly dispersed state. Therefore, the filler dispersion state in the material 3 that is suctioned from the container 2 by the pump 8 is favorably maintained during transportation to the material feed portion 10. There is no particular limitation regarding the installation location or the number of heaters 101 provided that the material is heated. There is no particular limitation regarding the installation location or the number of agitation mechanisms 4 provided that the material 3 is agitated. Likewise, there is no particular limitation regarding the installation location or the number of feed tubes 7 connected to the container 2 provided that the material 3 is transported to the material feed portion 10. In this regard, the material feed portion 10 may be laterally movable on the work table 5 or may be fixed provided that the material is fed onto the work table 5.

In the present embodiment, an example in which the container 2 is disposed under the work table 5 or the work table 5 is disposed in the container 2 is described. In the case in which the container 2 is disposed under the work table 5 or the work table 5 is disposed in the container 2, the material 3 that is not cured is allowed to drop downward and can be stored together with the material stored in the container 2. However, the system is not limited to this. For example, as in FIG. 2 illustrating a modified example of the first embodiment, the material may be stored in an external container 17. That is, as illustrated in FIG. 2, the material 18 may be stored in the external container 17 and may be fed to the material feed portion 10 from the external container 17 through the feed tube 7 and the material introduction port 20 by driving the pump 8 and the like by using the container control portion 613 described later. The external container 17 may include the heater 101 and/or the agitation mechanism 4 in the same manner as the container 2.

The curing light 13 is applied from a light irradiation portion composed of, for example, a light source 14, a mirror unit 15, and a lens unit 16. In the present specification, the light irradiation portion may be referred to as a curing-light irradiation unit. The light source 14 is, for example, a laser oscillator. In the case in which the material 3 is, for example, an ultraviolet-curable type, the wavelength of the irradiation light of the light source 14 that is suitable for the condition of the material and the like of the material 3 is selected within the range of about 200 to 400 nm. Regarding the typical light wavelength of the curing light 13, 254 nm or 365 nm is adopted. However, the wavelength of the irradiation light of the light source 14 is not limited to being within the ultraviolet range, and irradiation light within another wavelength range may be used in accordance with the material for forming the material 3. In addition to lasers, examples of the light source include systems using UV lamps and LEDs, and any one of these systems may be used.

The mirror unit 15 may be a scanning optical system composed of a galvanometer mirror unit and the like, and the irradiation spot of the light source 14 is scanned in the XY-direction through the lens unit 16 composed of a condensing lens and the like. Consequently, a section corresponding to a specific height of the shaped material 1 of the material 3 is cured.

Examples of a conceivable shaping system include a system in which two-dimensional scanning of the curing light and movement of work table 5 are alternately performed and a continuous shaping system in which the curing light is projected in the form of a moving image while the work table 5 is continuously moved by a lift (not illustrated in the drawing). In the case of the continuous shaping system, the light irradiation portion composed of the light source 14, the mirror unit 15, and the lens unit 16 may be formed as a moving-image projector which performs surface irradiation of a moving image.

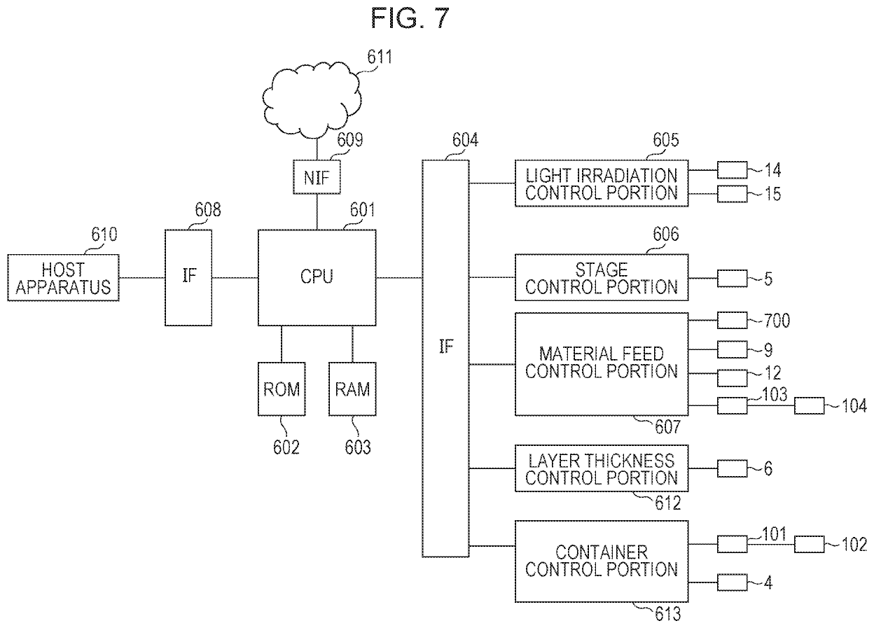

Next, a control system of the shaping apparatus and an example of the shaping control procedure will be specifically described. FIG. 7 illustrates the configuration of the control system of the shaping apparatus in FIG. 1. The configuration of the control system in FIG. 7 may also be adopted in a second embodiment.

In the control system in FIG. 7, ROM 602, RAM 603, interfaces 604 and 608, a network interface 609, and the like are arranged around CPU 601 that performs a main function of the control apparatus.

CPU 601 is connected to ROM 602, RAM 603, and various interfaces 604, 608, and 609. ROM 602 stores basic programs such as BIOS. The memory region of ROM 602 may include rewritable devices such as EPROM and/or EEPROM. RAM 603 is used as a work area configured to temporarily store the results of arithmetic processing of CPU 601. CPU 601 executes the shaping control procedure described later by executing the program recorded to (stored in) ROM 602.

In the case in which the program to execute the shaping control procedure described later is recorded to (stored in) ROM 602, the recording medium constitutes a computer-readable recording medium that stores the control procedure for realizing the present invention. In this regard, the program to execute the control procedure described later may be stored on fixed recording media such as ROM 602 or may be stored on removable computer-readable recording media such as on various types of flash memory and optical (or magnetic) discs. Such a storage form is usable for the case in which the program to execute the control procedure for realizing the present invention is installed or updated. In the case in which such a program is installed or updated, the above-described removable recording media may be used and, in addition, a system in which the program is downloaded from a network 611 through the network interface 609 may be used.

CPU 601 may communicate with other resources on the network (not illustrated in the drawing) that are connected through the network interface 609 and that communicate by using a protocol, such as TCP/IP. The network interface 609 may be made up of various network communication systems, such as wired connections (IEEE 802.3 or the like) and wireless connections (IEEE 802.xx or the like). The shaping control program described later may be downloaded from a server on the network 611 and may be installed to an external memory such as ROM 602 or on an HDD (not illustrated in the drawing), or a program which has been installed may be updated to a new version.

Three-dimensional (3D) data for performing three-dimensional (3D) additive manufacturing of the shaped material 1 are transmitted in a data format such as 3DCAD from a high-ranking host apparatus 610 through the interface 608. The interface 608 may be made up based on, for example, various types of serial or parallel interface standards. Meanwhile, the host apparatus 610 may be connected as a network terminal to the network 611. In this case, the host apparatus 610 also supplies shaping data to the present shaping apparatus as above.

CPU 601 controls the light source 14 and the mirror unit 15 through the interface 604 and a light-irradiation control portion 605. In addition, CPU 601 controls up-and-down movement of the work table 5 by using the lift (not illustrated in the drawing) through the interface 604 and a stage control portion 606. CPU 601 controls a material feed and movement unit 700, a shutter 9, the agitation mechanism 12, and the cooling mechanism 103 through the interface 604 and a material feed control portion 607. CPU 601 controls a squeegee 6 through the interface 604 and a layer thickness control portion 612. CPU 601 controls the heater 101 and the agitation mechanism 4 through the interface 604 and the container control portion 613. CPU 601 advances the overall shaping process by controlling each of the portions in accordance with the predetermined shaping sequence.

The interfaces 604 and 608 may be made up on the basis of, for example, various types of serial or parallel interface standards. In FIG. 7, for the sake of simplification, the interface 604 is indicated by a single block but may be made up of interface circuits having respective communication systems that differ from each other in accordance with the communications specification of each portion illustrated on the right-hand side of the interface 604.

Next, a shaping control method implemented by the above-described control system will be described.

The material feed and movement unit 700 is driven by the material feed control portion 607 so as to move the material feed portion 10 onto the work table 5. The shutter 9 of the material feed portion 10 is opened by the material feed control portion 607 so as to feed the material 3 onto the work table 5. After a predetermined time has elapsed, the shutter 9 is closed by the material feed control portion 607. The shutter 9 of the discharge port of the material feed portion 10 is opened by the material feed control portion 607 so as to feed the material 3 onto the work table 5. The material 3 is pushed out by the weight of the material 3, and the amount of the material fed may be determined by the time for which the shutter 9 is opened. Alternatively, the amount of the material fed may be determined by a piston or the like being driven to push the material 3 out.

Regarding the material feed portion 10 after feeding the material 3 onto the work table 5, the material feed and movement unit 700 is driven by the material feed control portion 607 so that the material feed portion 10 is moved beyond the irradiation region of the curing light and retracted.

The material feed control portion 607 can stop the agitation mechanism 12 at the timing of opening the shutter and can operate the agitation mechanism 12 at the timing of closing the shutter 9. Synchronizing the timings of opening and closing the shutter 9 with stopping and operating the agitation mechanism 12 enables the amount of the material 3 fed to be stabilized. In addition, entrainment of bubbles is avoided.

The squeegee 6 is moved by the layer thickness control portion 612 so as to level the fed material 3 to a predetermined thickness Δt. Thereafter, the light source 14 and the mirror unit 15 are controlled by the light irradiation control portion 605 so as to apply the curing light 13 configured to cure the material 3 from above the work table 5. The fed material 3 is selectively cured by the curing light 13 being applied to the necessary portion only. Consequently, the cured material (shaped material 1) is formed. That is, the work table 5 functions as the base plate configured to support a shaped section of the shaped material 1.

The lift (not illustrated in the drawing) is controlled by the stage control portion 606 so as to move the work table 5 downward. Displacement of the work table 5 at this time substantially corresponds to, for example, the thickness Δt of one layer that is cured by curing light irradiation and is set to be, for example, about 0.02 mm to 0.2 mm Regarding the material fed onto the work table 5 or the cured material (material), the material 3 is fed in an amount corresponding to one layer that is formed on the overall surface of the work table 5 and that has a thickness Δt. In this case, it is conjectured that the material 3 may drop from the end portion of the work table 5 into the container 2 so as to change the thickness Δt of the one layer. To suppress the thickness of the one layer from changing, a dummy form serving as a weir that prevents the material from flowing beyond the irradiation region of the curing light may be simultaneously shaped on the outer periphery of the cured material that is cured for shaping the shaped material 1. Alternatively, the work table 5 may be arranged in the container 2 so as to be surrounded by the material 3, the material may be fed by the material feed portion 10 to only the irradiation region of the curing light and the vicinity thereof, and the other region may be filled with the material 3 in the container 2.

The material feed and movement unit 700 is driven by the material feed control portion 607 so as to move the material feed portion 10 above the cured material (shaped material 1) shaped on the work table 5. The shutter 9 of the material feed portion 10 is opened by the material feed control portion 607 so as to feed the material 3 onto the cured material (shaped material 1) on the work table 5. After a predetermined time has elapsed, the shutter 9 is closed by the material feed control portion 607.

Regarding the material feed portion 10 that has fed the material 3 onto the cured material (shaped material 1) shaped on the work table 5, the material feed and movement unit 700 is driven by the material feed control portion 607 so that the material feed portion 10 is moved beyond the irradiation region of the curing light and retracted.

The squeegee 6 is moved by the layer thickness control portion 612 so as to level the fed material 3 to a predetermined thickness Δt from the upper surface of the cured material (shaped material 1). Thereafter, the light source 14 and the mirror unit 15 are controlled by the light irradiation control portion 605 so as to apply the curing light 13 configured to cure the material 3 from above the work table 5. Consequently, a second layer of the cured material (shaped material 1) is formed.

This operation is repetitively performed, and, as a result, a predetermined three-dimensional material (shaped material 1) placed on the work table 5 is produced.

According to the present embodiment, since the material feed portion includes the agitator, the material is agitated until just before the material is cured. Therefore, separation of filler due to precipitation is suppressed from occurring during material feeding, and a shaped material in which variations in the mechanical characteristics do not readily occur is produced.

### Second Embodiment

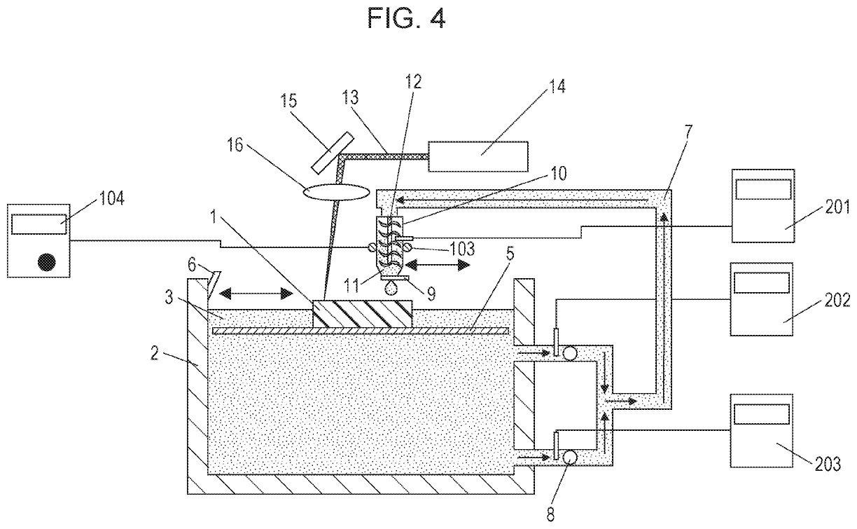

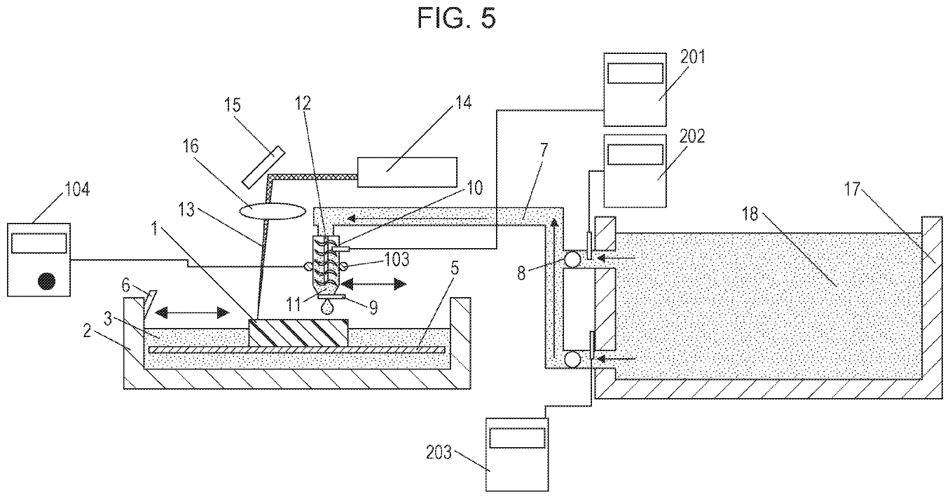

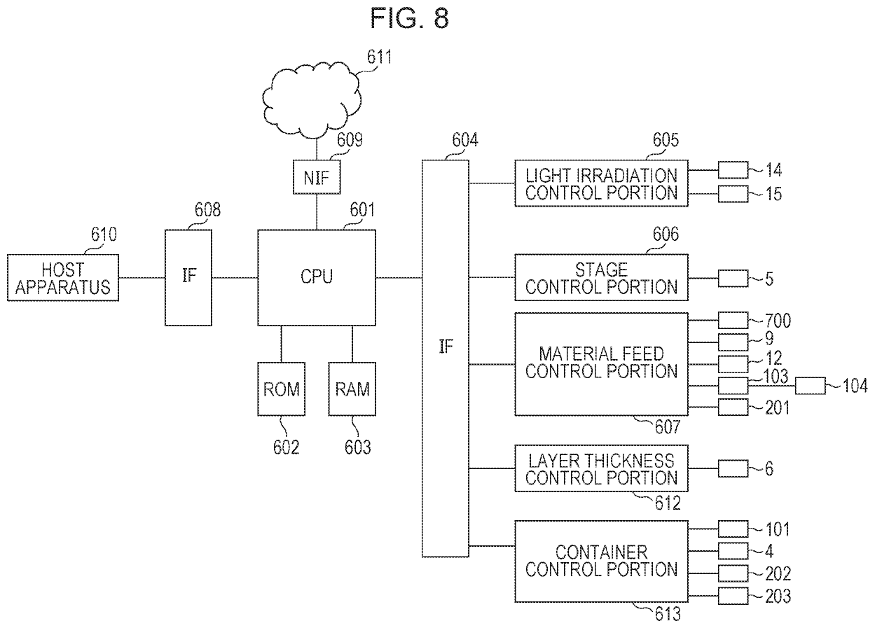

FIG. 4 is a simplified sectional view illustrating a second embodiment that is an example of a three-dimensional-shaping apparatus according to the present invention. FIG. 5 is a simplified sectional view illustrating a modified example of the second embodiment. FIG. 8 is a block diagram illustrating a configuration example of the control system of the shaping apparatus according to the second embodiment. In FIG. 4, FIG. 5, and FIG. 8, the same configurations as in the first embodiment are indicated by the same reference and explanations thereof are omitted.

In the present invention, the material feed portion 10 includes an agitation mechanism. The material feed portion 10 including the agitation mechanism 12 enables separation of filler due to precipitation to be suppressed from occurring during material feeding. In the first embodiment, the example in which the material feed portion 10 includes the agitation mechanism 12 and, in addition, the heater 101 and the agitation mechanism 4 are included in the container 2 storing the filler-containing material 3 that is in a molten (uncured) state and that is fed to the material feed portion 10 is described. In another example described above, the heater 101 and the agitation mechanism 4 are included in the external container 17 storing the filler-containing material 3 that is in a molten (uncured) state and that is fed to the material feed portion 10.

In the present embodiment, an example in which a viscosity adjusting mechanism is included in place of the heater 101 and the agitation mechanism 4 or in addition to the heater 101 and the agitation mechanism 4 between the container 2 and the material feed portion 10 will be described.

In the same manner as in the first embodiment, regarding a photo-curable material used for shaping, the filler-containing material in the container 2 is suctioned by the pump 8 that is disposed at the inlet of the feed tube 7 and that is driven by the container control portion 613 and is transported to the material feed portion 10 through the feed tube 7. In the present embodiment, at least two feed tubes 7 are connected to the container 2, and the material in the container 2 is suctioned by the pump disposed at the inlet of each of the at least two feed tubes 7 due to the container control portion 613. Of the at least two feed tubes, one feed tube can be disposed at the upper portion of the container 2, and another feed tube can be disposed at the lower portion. Viscosity measuring instruments 202 and 203 are disposed in the respective feed tubes. The material feed portion 10 is also provided with a viscosity measuring instrument 201.

The material is transported to the material feed portion 10, and the viscosity of the material in the material feed portion 10 including the agitation mechanism 12 is displayed by the viscosity measuring instrument 201. The viscosity in the feed tube and the viscosity in the material feed portion 10 are measured by a known viscosity measuring instrument. Regarding the viscosity measuring instrument 201, an instrument that calculates the viscosity on the basis of the agitation resistance and the power consumption of the agitation mechanism 12 may be used. A vibration type viscometer may be used as the viscosity measuring instruments 202 and 203 disposed in the respective feed tubes. The value of the viscosity in the material feed portion 10 is stored on the external memory unit (not illustrated in the drawing) such as ROM 602 or HDD by the material feed control portion 607. The values of the viscosity measuring instruments 202 and 203 disposed in the two feed tubes are also stored on an external memory unit (not illustrated in the drawing) such as ROM 602 or HDD by the container control portion 613. In the case in which the stored value of the viscosity of the material in the material feed portion 10 does not fall within a predetermined viscosity range, CPU determines the amounts (mixing ratio) of the materials suctioned by the pumps from the container 2 to the respective feed tubes on the basis of the values of the viscosity measuring instruments 202 and 203 disposed in the respective feed tubes. The amounts (mixing ratio) of the materials suctioned from the container 2 to the respective feed tubes are repetitively adjusted until the viscosity in the material feed portion 10 becomes a predetermined viscosity (viscosity suitable for processing the material). The transported material may be maintained in the state of being cooled and agitated in the material feed portion 10 including the cooling mechanism 103 and the agitation mechanism 12, although the state is not limited to this.

Replenishment of the material feed portion 10 with the material may utilize the material 3 stored in the container 2 provided with the work table 5 or may utilize the external container 17 not provided with the work plate 5 illustrated in FIG. 5. There is no particular limitation regarding the disposition locations of the feed tubes 7 connected to the container 2 provided that the number is 2 or more. However, the feed tubes can be disposed at locations at which there is a large viscosity difference between the materials suctioned. For example, at least one feed tube can be connected to each of the upper portion and the lower portion of the container.

Meanwhile, a plurality of containers 2 storing materials having viscosities that differ from each other may be included. Alternatively, a plurality of external containers 17 storing materials having viscosities that differ from each other may be included. In this case, the material may be fed to the material feed portion from each of the plurality of containers storing materials having viscosities that differ from each other.

### EXAMPLES

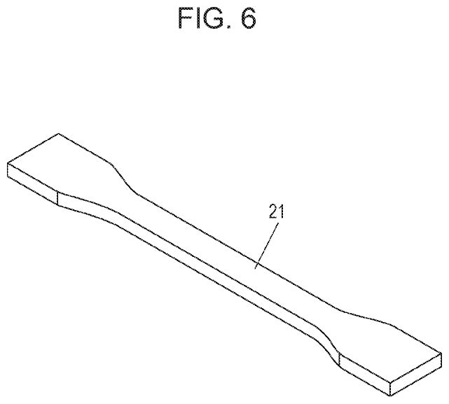

The examples according to the present invention will be described below in detail. The shaping apparatus illustrated in FIG. 1 was used, and a shaping experiment of a test piece was performed in an environment at about 25° C. A dumbbell type tensile test piece specified in accordance with JIS, as illustrated in FIG. 6, was used as the test piece. Ultraviolet rays with a wavelength of 355 nm and a maximum output of 1 W was used as the laser beam 13. The beam spot diameter when condensed on the work table 5 was set to be 0.1 to 0.3 mm. The size of the container 2 was set to be about 500 mm×500 mm×300 mm. The size of the work table 5 was set to be about 400 mm×400 mm. The size of the discharge port 11a of the material feed portion 10 was set to be about 050 mm. The overall surface of the work table 5 was used, and a plurality of test pieces having a size of 20×170×4 mm were arranged at a regular interval in different orientations. The materials used in the experiments are described in Table 1.

Regarding material A, SOMOS produced by DSM, (registered trademark) PerFORM, was used. Regarding material B, SCR-801 produced by JSR Corporation was used.

TABLE 1
Material used for experiment

| | | | Viscosity |
|---|---|---|---|
| | Base | Additive | [mPa · s/25° C.] |
| Material | epoxy/ | inorganic | 1900 |
| A | acryl | filter | |
| Material | epoxy | inorganic | 5000 |
| B | | filter | |

In the table, “viscosity” denotes an average viscosity in a state in which additives are homogeneously dispersed in an environment at room temperature of 25° C.

### Example 1, Example 2, and Comparative Example 1

Material A was used, and the viscosity of the material sample was measured by using a rheometer while the holding temperature was changed. The viscosity measurement result is described in Table 2.

TABLE 2

| | Temperature | Viscosity |
|---|---|---|
| | [° C.] | [mPa · s] |
| Sample 1 | 55 | 250 |
| Sample 2 | 50 | 400 |
| Sample 3 | 45 | 550 |
| Sample 4 | 40 | 700 |
| Sample 5 | 35 | 950 |
| Sample 6 | 30 | 1300 |
| Sample 7 | 25 | 1900 |

The container 2 in the state of being filled with material A was left standing for a predetermined time, and thereafter the temperature of the material in the container 2 was changed from room temperature in increments of 5° C., agitation was performed for a predetermined time, and the filler dispersion state was evaluated. The evaluation result were expressed in two stages of A: good and B: filler was deposited on part of container bottom. The results are described in Table 3.

TABLE 3

| | Agitation | Viscosity [mPa · s] | | | |
|---|---|---|---|---|---|
| | temperature | Liquid | | | Evaluation |
| | [° C.] | surface | Center | Bottom | result |
| Sample 1 | 55 | 250 | 250 | 250 | A |
| Sample 2 | 50 | 400 | 400 | 400 | A |
| Sample 3 | 45 | 550 | 550 | 550 | A |
| Sample 4 | 40 | 700 | 700 | 700 | A |
| Sample 5 | 35 | 950 | 950 | 950 | A |
| Sample 6 | 30 | 1300 | 1300 | 1300 | A |
| Sample 7 | 25 | 1400 | 1900 | 2500 | B |

According to Table 3 above, the material in the container 2 being agitated while heated enabled a favorable filler dispersion state to be obtained. In the case in which the material in the container that stored a large amount of the material was agitated in a high-viscosity state without being heated, variations in the viscosity were observed in the container. Even at the visual observation level, filler deposition was observed on part of the bottom of the container.

In example 1, the material agitated under the temperature condition of each of sample 1 to sample 6 described in Table 3 was transported to the material feed portion. In the material feed portion, the material was cooled to room temperature of 25° C. while agitated, and the viscosity was set to be 1,900 [mPa·s]. Thereafter, the shutter of the material feed portion was opened, the material was fed onto the work table 5, a test piece was produced, and the shape precision of the test piece was evaluated.

In example 2, the material agitated under the temperature condition of each of sample 1 to sample 6 described in Table 3 was transported to the material feed portion. Thereafter the material was agitated in the material feed portion, the shutter of the material feed portion was opened, the material was fed onto the work table 5, a test piece was produced, and the shape precision of the test piece was evaluated.

In comparative example 1, the material agitated under the temperature condition of each of sample 1 to sample 6 described in Table 3 was transported to the material feed portion not including an agitator. Thereafter, the shutter of the material feed portion was opened, the material was fed onto the work table 5, a test piece was produced, and the shape precision of the test piece was evaluated.

The results were ranked on a scale of 3 stages, A: good, B: better than the comparative example but inferior to A, and C: poor. The evaluation results are described in Table 4.

TABLE 4

| | Evaluation result | | |
|---|---|---|---|
| | | | Comparative |
| | Example 1 | Example 2 | example 1 |
| Sample 1 | A | B | C |
| Sample 2 | A | B | C |
| Sample 3 | A | B | C |
| Sample 4 | A | B | C |
| Sample 5 | A | B | C |
| Sample 6 | A | B | C |

According to Table 4, in example 1 in which agitation and cooling were performed so as to adjust the viscosity in the material feed portion, defects such as streaks and unevenness did not occur during the surface-leveling step by the squeegee 6, and the shape precision in shaping was favorable. In example 2 in which agitation was performed but cooling was not performed in the material feed portion, occurrences of streaks or unevenness were observed to some extent but at an insignificant level, and the result was better than the comparative example. In comparative example 1 in which neither agitation nor cooling was performed in the material feed portion, defects such as streaks and unevenness occurred.

Next, the mechanical characteristics of the dumbbell type tensile test piece 21 shaped in each of example 1, example 2, and comparative example 1 were evaluated. The results were ranked on a scale of 3 stages, A: good, B: better than the comparative example but inferior to A, and C: poor. The results are described in Table 5.

TABLE 5

| | Evaluation result | | |
|---|---|---|---|
| | | | Comparative |
| | Example 1 | Example 2 | example 1 |
| Sample 1 | B | B | C |
| Sample 2 | A | B | C |
| Sample 3 | A | B | C |
| Sample 4 | A | B | C |
| Sample 5 | A | B | C |
| Sample 6 | A | B | C |

According to Table 5, in example 1 in which agitation and cooling were performed so as to adjust the viscosity in the material feed portion, the filler dispersion state was maintained until just before photo-curing, and an optical shaping part having favorable mechanical characteristics was obtained. However, if the material in the container was heated to 55° C. or higher, the material heat-deteriorated, and the mechanical strength deteriorated to some extent. In example 2 in which agitation was performed but cooling was not performed in the material feed portion, deterioration in the mechanical strength was observed to some extent but at an insignificant level, and the result was better than the comparative example. In comparative example 1 in which neither agitation nor cooling was performed in the material feed portion, the mechanical strength deteriorated.

### Example 3, Example 4, and Comparative Example 2

The same optical shaping apparatus as that in example 1 was used, and an experiment was performed using material B described in Table 1. To begin with, the viscosity of the material sample was measured by using a rheometer while the holding temperature was changed. The viscosity measurement result is described in Table 6.

TABLE 6

| | Temperature | Viscosity |
|---|---|---|
| | [° C.] | [mPa · s] |
| Sample 8 | 55 | 800 |
| Sample 9 | 50 | 1000 |
| Sample 10 | 45 | 1400 |
| Sample 11 | 40 | 1900 |
| Sample 12 | 35 | 2350 |
| Sample 13 | 30 | 3300 |
| Sample 14 | 25 | 5000 |

According to Table 6 above, it was ascertained that the viscosity of the material was reduced by heating.

The container 2 in the state of being filled with material B was left standing for a predetermined time, and thereafter the temperature of the material in the container 2 was changed from room temperature in increments of 5° C., agitation was performed for a predetermined time, and the filler dispersion state was evaluated. The evaluation result were expressed in two stages of A: good and B: filler was deposited on part of container bottom. The results are described in Table 7.

TABLE 7

| | Agitation | Viscosity [mPa · s] | | | |
|---|---|---|---|---|---|
| | temperature | Liquid | | | Evaluation |
| | [° C.] | surface | Center | Bottom | result |
| Sample 8 | 55 | 800 | 800 | 800 | A |
| Sample 9 | 50 | 1000 | 1000 | 1000 | A |
| Sample 10 | 45 | 1400 | 1400 | 1400 | A |
| Sample 11 | 40 | 1400 | 1900 | 2500 | A |
| Sample 12 | 35 | 1650 | 2350 | 3200 | B |
| Sample 13 | 30 | 2300 | 3300 | 4500 | B |
| Sample 14 | 25 | 3500 | 5000 | 6500 | B |

According to Table 7 above, the material in the container being agitated while heated so that the material viscosity was reduced to a predetermined value or less enabled a favorable filler dispersion state to be obtained. In the case in which the material in the container that stored a large amount of the material was agitated in a high-viscosity state due to a low heating temperature or without being heated, variations in the viscosity were observed in the container. Even at the visual observation level, filler deposition was observed on part of the bottom of the container.

In example 3, the material agitated under the temperature condition of each of sample 8 to sample 11 described in Table 7 was transported to the material feed portion. In the material feed portion, each of sample 8 to sample 10 was cooled to room temperature of 25° C. while agitated so as to set the viscosity to be 5,000 [mPa·s]. Thereafter, the shutter of the material feed portion was opened, the material was fed onto the work table 5, a test piece was produced, and the shape precision of the test piece was evaluated. Sample 11 was cooled to room temperature of 20° C. so as to set the viscosity to be 7,000 [mPa·s]. Thereafter, the shutter of the material feed portion was opened, the material was fed onto the work table 5, a test piece was produced, and the shape precision of the test piece was evaluated.

In example 4, the material agitated under the temperature condition of each of sample 8 to sample 11 described in Table 7 was transported to the material feed portion. Thereafter the material was agitated in the material feed portion, the shutter of the material feed portion was opened, the material was fed onto the work table 5, a test piece was produced, and the shape precision of the test piece was evaluated.

In comparative example 2, the material agitated under the temperature condition of each of sample 8 to sample 11 described in Table 7 was transported to the material feed portion not including an agitator. Thereafter, the shutter of the material feed portion was opened, the material was fed onto the work table 5, a test piece was produced, and the shape precision of the test piece was evaluated.

The results were ranked on a scale of 3 stages, A: good, B: better than the comparative example but inferior to A, and C: poor. The evaluation results are described in Table 8.

TABLE 8

| | Evaluation result | | |
|---|---|---|---|
| | | | Comparative |
| | Example 3 | Example 4 | example 2 |
| Sample 8 | A | B | C |
| Sample 9 | A | B | C |
| Sample 10 | A | B | C |
| Sample 11 | B | B | C |

According to Table 8, in example 3 in which agitation and cooling were performed so as to adjust the viscosity in the material feed portion, defects such as streaks and unevenness did not occur during the surface-leveling step by the squeegee 6, and the shape precision in shaping was favorable. However, if the material viscosity was increased to 7,000 [mPa·s] or more by cooling, occurrences of streaks or unevenness were observed to some extent but at an insignificant level, and the result was better than the comparative example. In example 4 in which agitation was performed but cooling was not performed in the material feed portion, occurrences of streaks or unevenness were observed to some extent but at an insignificant level, and the result was better than the comparative example. In comparative example 2 in which neither agitation nor cooling was performed in the material feed portion, defects such as streaks and unevenness occurred.

Next, the mechanical characteristics of the dumbbell type tensile test piece 21 shaped in each of example 3, example 4, and comparative example 2 were evaluated. The results were ranked on a scale of 3 stages, A: good, B: better than the comparative example but inferior to A, and C: poor. The results are described in Table 9.

TABLE 9

| | Evaluation result | | |
|---|---|---|---|
| | | | Comparative |
| | Example 3 | Example 4 | example 2 |
| Sample 8 | B | B | C |
| Sample 9 | A | B | C |
| Sample 10 | A | B | C |
| Sample 11 | B | B | C |

According to Table 9, in example 3 in which agitation and cooling were performed so as to adjust the viscosity to less than 7,000 [mPa·s] in the material feed portion, the filler dispersion state was maintained until just before photo-curing, and an optical shaping part having favorable mechanical characteristics was obtained. However, if the material in the container was heated to 55° C. or higher, the material heat-deteriorated, and the mechanical strength deteriorated to some extent. In example 4 in which agitation was performed but cooling was not performed in the material feed portion, deterioration in the mechanical strength was observed to some extent but at an insignificant level, and the result was better than the comparative example. In comparative example 2 in which neither agitation nor cooling was performed in the material feed portion, the mechanical strength deteriorated.

### Example 5

In the present experiment, material A was used. The results of viscosity measurements just after stopping the agitator of the container 2, after a lapse of 24 hours, and after a lapse of 48 hours are described in Table 10. The viscosity herein is the value in an environment at room temperature of 25° C. of each of the viscosity measuring instrument 202 attached to the upper portion feed tube, the viscosity measuring instrument 203 attached to the lower portion feed tube, and the viscosity measuring instrument 201 attached to the material feed portion.

TABLE 10

| | Just after | | | | |
|---|---|---|---|---|---|
| | stopping | | | | |
| | agitation | After lapse of 24 hours | | After lapse of 48 hours | |
| | Initial | Initial | Re- | Initial | Re- |
| | measurement | measurement | measurement | measurement | measurement |
| Upper portion | 50% | 50% | 30% | 50% | 20% |
| feed tube | | | | | |
| Lower portion | 50% | 50% | 70% | 50% | 80% |
| feed tube | | | | | |
| Value of | 1900 | 1200 | 1200 | 500 | 500 |
| viscosity | | | | | |
| measuring | | | | | |
| instrument | | | | | |
| (in upper | | | | | |
| portion | | | | | |
| feed tube) | | | | | |
| Value of | 1900 | 1700 | 1700 | 1400 | 1400 |
| viscosity | | | | | |
| measuring | | | | | |
| instrument | | | | | |
| (in lower | | | | | |
| portion | | | | | |
| feed tube) | | | | | |
| Value of | 1900 | 2200 | 1950 | 2300 | 1940 |
| viscosity | | | | | |
| measuring | | | | | |
| instrument | | | | | |
| (in | | | | | |
| material | | | | | |
| feed unit) | | | | | |
| Measurement | A | B | A | B | A |
| result | | | | | |

According to Table 10, it was ascertained that, even after a lapse of 24 hours and after a lapse of 48 hours, the viscosity in the material feed portion of the material transported from the feed tube to the material feed portion did not reach the viscosity suitable for shaping.

Next, the material was fed to the material feed portion 10 again in accordance with the mixing ratio calculated on the basis of feedback of the values of the viscosity measuring instruments 202 and 203 of the feed tubes. As a result, it was ascertained that the viscosity in the material feed portion 10 fell within the range suitable for shaping, and the shape precision of the shaped object was evaluated. The results were ranked on a scale of 2 stages, A: within range and B: beyond range.

### Example 6

The same shaping apparatus as that in example 5 was used, and an experiment was performed using material B described in Table 1. To begin with, the results of viscosity measurements just after stopping the agitator of the container 2, after a lapse of 24 hours, and after a lapse of 48 hours are described in Table 11. The viscosity herein is the value in an environment at room temperature of 25° C. of each of the viscosity measuring instrument 202 attached to the upper portion feed tube, the viscosity measuring instrument 203 attached to the lower portion feed tube, and the viscosity measuring instrument 201 attached to the material feed portion.

TABLE 11

| | Just after | | | | |
|---|---|---|---|---|---|
| | stopping | | | | |
| | agitation | After lapse of 24 hours | | After lapse of 48 hours | |
| | Initial | Initial | Re- | Initial | Re- |
| | measurement | measurement | measurement | measurement | measurement |
| Upper portion | 50% | 50% | 70% | 50% | 65% |
| feed tube | | | | | |
| Lower portion | 50% | 50% | 30% | 50% | 35% |
| feed tube | | | | | |
| Value of | 4900 | 4500 | 4500 | 4000 | 4000 |
| viscosity | | | | | |
| measuring | | | | | |
| instrument | | | | | |
| (in upper | | | | | |
| portion | | | | | |
| feed tube) | | | | | |
| Value of | 4900 | 6000 | 6000 | 6900 | 6900 |
| viscosity | | | | | |
| measuring | | | | | |
| instrument | | | | | |
| (in lower | | | | | |
| portion | | | | | |
| feed tube) | | | | | |
| Value of | 4900 | 5250 | 4950 | 5450 | 5015 |
| viscosity | | | | | |
| measuring | | | | | |
| instrument | | | | | |
| (in | | | | | |
| material | | | | | |
| feed unit) | | | | | |
| Measurement | A | B | A | B | A |
| result | | | | | |

According to Table 11, it was ascertained that, even after a lapse of 24 hours and after a lapse of 48 hours, the viscosity in the material feed portion of the material transported from the feed tube to the material feed portion did not reach the viscosity suitable for shaping.

Next, the material was fed to the material feed portion 10 again in accordance with the mixing ratio calculated on the basis of feedback of the values of the viscosity measuring instruments 202 and 203 of the feed tubes. As a result, it was ascertained that the viscosity in the material feed portion 10 fell within the range suitable for shaping, and the shape precision of the shaped object was evaluated. The results were ranked on a scale of 2 stages, A: within range and B: beyond range.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-189802, filed Oct. 16, 2019, which is hereby incorporated by reference herein in its entirety.

What is claimed is:

1. A shaping apparatus configured to shape a shaped material by irradiating a material discharged from a material feed portion with light so as to cure the material, comprising:
a material feed portion, comprising an agitator configured to agitate the material before discharge from the material feed portion.

2. The shaping apparatus according to claim 1, further comprising a cooler configured to cool the material before discharge from the material feed portion.

3. The shaping apparatus according to claim 1, further comprising a container configured to store the material before discharge and a feed tube to transport the material to the material feed portion, and the container has a heater configured to heat the stored material.

4. The shaping apparatus according to claim 3, wherein the container has the agitator configured to agitate the stored material.

5. The shaping apparatus according to claim 3, further comprising a viscosity measuring instrument configured to measure the viscosity of the material transported from the container.

6. The shaping apparatus according to claim 3, wherein the feed tube comprising a first part connected to an upper portion of the container and a second part connected to a lower portion of the container.

7. The shaping apparatus according to claim 6, wherein each of the first and second parts of the feed tube is provided with a viscosity measuring instrument.

8. The shaping apparatus according to claim 6, wherein an amount of the material suctioned into the first part of the feed tube connected to the upper portion differs from the amount of the material suctioned into the second part of the feed tube connected to the lower portion.

9. The shaping apparatus according to claim 1, further comprising a control portion,
wherein the control portion is configured to stop the agitator, open a shutter to discharge the material, close the shutter, and thereafter operate the agitator of the material feed portion.

10. A method for manufacturing a shaped material comprising repetition of the steps of:
discharging a material from a material feed portion; and
stopping discharge of the material from the material feed portion and forming a cured layer by irradiating the discharged material with curing light,
wherein the material feed portion agitates the material stored in the material feed portion while discharge of the material is stopped.

11. The method for manufacturing a shaped material according to claim 10, wherein the material stored in the material feed portion is transported from the container in which the material is stored.

12. The method for manufacturing a shaped material according to claim 10, wherein the material stored in the material feed portion is cooled.
